(19) United States
(12) Patent Application Publication
(10) Pub. No.: US 2025/0350463 A1
(43) Pub. Date: Nov. 13, 2025

(54) SYSTEMS AND METHODS FOR HIERARCHICAL OBJECT STORAGE OF TOKENIZED ASSETS AND RELATED DATA

(71) Applicant: Balcony Technology Group, Inc., Hoboken, NJ (US)

(72) Inventors: John Belitsky, Leonia, NJ (US); Daniel C. Silverman, Hoboken, NJ (US)

(21) Appl. No.: 18/661,620

(22) Filed: May 11, 2024

(51) Int. Cl. H04L 9/32; G06Q 50/16

(52) U.S. Cl. CPC H04L 9/3213; G06Q 50/16; H04L 9/3239; G06Q 2220/00

(57) ABSTRACT

Computing systems are configured to provide a hierarchical organization of blockchain operations, efficiently storing recursive hashes that allow quick verification of received data and data state. Received data from authorized users in associated and stored by representation at a corresponding position in the hierarchy. The computer hashes and tokenizes received data with the hash and stores the same. Each token created is then separately hashed with time and creator into a listing of all such tokens within an object. Such re-hashing is reiterated up each hierarchy level and stored in the containing object. The lists of all hashes at each level can be used to verify a state or individual document that will be reflected in the stored listings is accurate or currently true. Additionally, user actions and histories, as well as state progression and history, can be queried and reported easily with the lists.

### BACKGROUND

Blockchain is a method of information arrangement useable with a distributed ledger among several different users, computers, or nodes. In blockchain, blocks of data are linked together cryptographically and may include data identifying files, properties, transactions, used, or any other type of useful reference together with a hash or hashes of adjacent block(s). Because each block identifies the next via this hash, the blocks form a chain of linked records. Any change to data identified in a block, such as a new asset, change in owner, new URL or pointer, etc. is recorded and traceable up through each block in the chain. Because of this chained relationship, individual computer nodes, potentially differently-operated and otherwise non-related, can store any set of block(s) of the blockchain, and these relationships along the chain can be validated by a shared protocol for interoperability, validation, and consensus building as to chain membership and changes to underlying data.

Tokens are a further type of data recordable in blocks of a blockchain. These may be uniquely-identified data pieces that include or are associated with media, legal documents, files, URLs, passwords, or a real-world property in a constant manner, in which case they may be referred to as non-fungible tokens (NFTs) recorded on a blockchain. Token creation, properties, and operations may be similarly controlled by shared protocols, including, for example, the Solana Program Library (SPL) or Ethereum Request for Comment (ERC) protocols governing particular interactions among tokens and blockchains in general. In this way, NFTs on a blockchain can be used to track, verify, and indicate ownership of represented digital or physical assets, as well as all related data and relationship to other information of the asset. Because of this reliability, there may be marketplaces for NFTs of various kinds, as well as incentives to support blockchains operating the same through nodes that build consensus and mint/mine NFTs and transactions for marketplace operations.

This background provides a useful baseline or starting point from which to better understand some example embodiments discussed below. Except for any clearly-identified third-party subject matter, likely separately submitted, this Background and any figures are by the Inventor(s), created for purposes of this application. Nothing in this application is necessarily known or represented as prior art.

### SUMMARY

Example embodiments and methods include computing systems configured with memory and processors that can electronically receive, generate, and/or store cryptographic and distributed data in a hierarchical fashion to provide ease or verification and organization of data state. Example embodiments can receive a diverse level of information, including user input and files, from any number of distinct and independent networked users, determine a target object for the received input that uniquely stores information of a type provided, and then hash the input into a lowest-level string and tokenize the same while re-hashing the resulting lowest-level string and token into a higher-level string. These generated hashes and tokens are stored in their target object. Any number and division of data can be handled in example embodiments, including real estate assets with corresponding hierarchy tiers organized around overall property, transaction type, user type, document type, etc. provided from user input. Example embodiments may operate on any blockchain and cryptographic standard capable of this intake and storage, including ERC-1155Delta objects storing multiple ERC-721 tokens and the generated hashes. The veracity of any provided document, as well as overall data state of the generated hierarchy, can be checked at each tier through the hashes saved at each level, because the hashes at each level reflect all states and changes through each lower level in such hierarchies.

### BRIEF DESCRIPTIONS OF THE DRAWINGS

Example embodiments will become more apparent by describing, in detail, the attached drawings, wherein like elements are represented by like reference numerals, which are given by way of illustration only and thus do not limit the terms which they depict.

FIG. 1 is a schematic of an example embodiment blockchain network.

FIG. 2 is a detail illustration of an example blockchain segment from the blockchain network of FIG. 1.

FIG. 3 is a data flow schematic of an example method of operating the network of FIG. 1.

FIG. 4 is a flow chart illustrating an example method of operating the network of FIG. 1.

FIG. 5 is a schematic illustrating an example embodiment object memory configuration useable in the network of FIG. 1.

### DETAILED DESCRIPTION

Because this is a patent document, general broad rules of construction should be applied when reading it. Everything described and shown in this document is an example of subject matter falling within the scope of the claims, appended below. Any specific structural and functional details disclosed herein are merely for purposes of describing how to make and use examples. Several different embodiments and methods not specifically disclosed herein may fall within the claim scope; as such, the claims may be embodied in many alternate forms and should not be construed as limited to only examples set forth herein.

Membership terms like “comprises,” “includes,” “has,” or “with” reflect the presence of stated features, characteristics, steps, operations, elements, and/or components, but do not themselves preclude the presence or addition of one or more other features, characteristics, steps, operations, elements, components, and/or groups thereof. Rather, exclusive modifiers like “only” or “singular” may preclude presence or addition of other subject matter in modified terms. The use of permissive terms like “may” or “can” reflect optionality such that modified terms are not necessarily present, but absence of permissive terms does not reflect compulsion. In listing items in example embodiments, conjunctions and inclusive terms like “and,” “with,” and “or” include all combinations of one or more of the listed items without exclusion of non-listed items. The use of “etc.” is defined as “et cetera” and indicates the inclusion of all other elements belonging to the same group of the preceding items, in any “and/or” combination(s). Modifiers “first,” “second,” “another,” etc. do not confine modified items to any order. These terms are used only to distinguish one element from another; where there are “second” or higher ordinals, there merely must be that many number of elements, without necessarily any difference or other relationship among those elements.

When an element is related, such as by being “connected,” “coupled,” “on,” “attached,” “fixed,” etc., to another element, it can be directly connected to the other element, or intervening elements may be present. In contrast, when an element is referred to as being “directly connected,” “directly coupled,” etc. to another element, there are no intervening elements present. Other words used to describe the relationship between elements should be interpreted in a like fashion (e.g., “between” versus “directly between,” “adjacent” versus “directly adjacent,” etc.).

As used herein, singular forms like “a,” “an,” and “the” are intended to include both the singular and plural forms, unless the language explicitly indicates otherwise. Indefinite articles like “a” and “an” introduce or refer to any modified term, both previously-introduced and not, while definite articles like “the” refer to the same previously-introduced term. Relative terms such as “almost” or “more” and terms of degree such as “approximately” or “substantially” reflect 10% variance in modified values or, where understood by the skilled artisan in the technological context, the full range of imprecision that still achieves functionality of modified terms. Precision and non-variance are expressed by contrary terms like “exactly.”

As used herein “ERC” refers to the Ethereum Request for Comment/s protocol for operating the Ethereum blockchain, which are incorporated herein by reference in their entirety. Specifically-numbered ERCs, such as ERC-1155Delta and ERC-721, include those individual standards as of the filing date of the present application, and all previous interoperable versions of the same. Additionally, ERC and distributed storage functionality herein includes any other or future blockchain protocol having substantially equivalent functionality to the ERC. Similarly, as used herein, “SHA” refers to the Secure Hash Algorithm 2 function set, which is incorporated herein by reference in its entirety. Specifically-numbered SHAs, such as SHA-256 or SHA-512, include the standard functions computed with the listed numbers of bit words as of the filing date of the present application, and all previous interoperable versions of the same. Additionally, SHA and cryptographic functionality herein includes any other or future hashing protocol having substantially equivalent functionality to the SHA.

The structures and operations discussed below may occur out of the order described and/or noted in the figures. For example, two operations and/or figures shown in succession may be executed concurrently or may be executed in the reverse order, depending upon the functionality/acts involved. Similarly, individual operations within example methods described below may be executed repetitively, individually or sequentially, so as to provide looping or other series of operations aside from exact operations described below. It should be presumed that any embodiment or method having features and functionality described below, in any workable combination, falls within the scope of example embodiments.

The inventors have recognized that many real-world assets and transactions entail multiple, potentially hundreds or thousands, of distinct users providing equally numerous pieces of documentation, often in a mix of digital and paper media. For example, for a single building in real-estate, owners, government officials, lessors, guests, and operators may generate innumerable transactions regarding permitting, sales, rents, maintenance, taxation, etc. of the building. Each actor may provide different types of documents, media, or other information to these transactions, and the are conventionally separately-stored on a per user basis, potentially across multiple unrelated and incompatible platforms. The inventors have thus recognized a need to have all potentially relevant documentation and information securely stored in a single protocol and/or vehicle that is universally accessible for all user purposes. To overcome these newly-recognized computing problems as well as others, the inventors have developed example embodiments and methods described below to address these and other problems recognized by the inventors with unique solutions improving computer operation enabled by example embodiments.

The present invention is systems and methods of storing, retrieving, and organizing data in a cryptographic manner. In contrast to the present invention, the few example embodiments and example methods discussed below illustrate just a subset of the variety of different configurations that can be used as and/or in connection with the present invention.

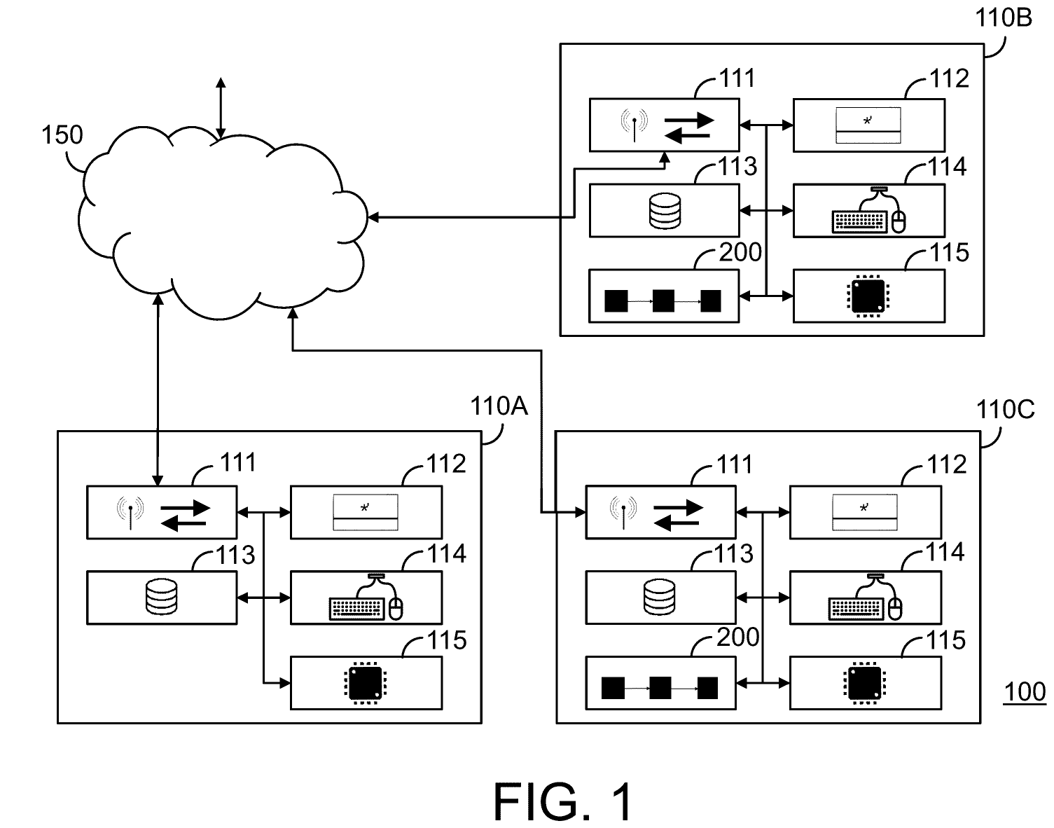

FIG. 1 shows an example embodiment node network 100 including one or more clients 110, including, servers, nodes, and/or user devices, configured and networked to execute example methods and/or operate example embodiments. As shown in FIG. 1, network 100 may include user device 110A, node 110B, and/or server 110C. Clients 110 may include processors 115, displays or other output 112, input devices 114, ports and communication systems 111, and/or memory 113. Processor 115 may be hardware processor or combination of processors, such as a central or graphics processing unit, an application-specific integrated circuit, field-programmable gate array, etc. with attendant cache and/or programming or other configuration. Inputs 114 may include any input devices and/or sensors, such as a keyboard, mouse, touchscreen, microphone, camera, etc.

Communications systems 111 may include hardware, firmware, and/or software configured with protocols or connections to interface with communication network 150, including ethernet cables, transceivers, and/or antennae configured for Wi-Fi, Bluetooth, cellular, etc. connections. Memory 113 include a storage device or devices that store information, code, instructions, values, etc., that can be used by processor 115 to execute example methods, including, for example operation of or support for a blockchain. Memory 113 may include any volatile or non-volatile memory, including random access, read-only, or electronically erasable programmable read-only memory, flash drives, hard disks, solid state or optical drives, etc. in any format, including typical file allocation formats as well as object memory storing cryptographic tokens. Memory 113 can have encoded thereon a computer program for controlling operation of computing device 110.

Server 110C and node 110B may have similar components in full or part as user device 110A. Node 110B and server 110C may further store, operation, and or maintain blockchain 200 in full or in part. Node 110B and/or server 110C may store and/or operate on protocols necessary to grow, maintain, determine consensus on, and otherwise operate and store blockchain 200 in accordance with example methods.

Server 110C may further include instructions and other configurations to provide instructions, webpages, downloadable content, application interfaces to/from user device 110A, including provisioning and/or receiving content for blockchain 200. Server 110C may include a blockchain manager, master instructions, protocols, verification tools, and similar configuration to ensure nodes 110B and user devices 110A are properly following protocols and interacting with blockchain 200, including authentication and validation tools as well as ownership data to ensure example methods are executed with fidelity in a distributed environment with multiple independent actors. For example, server 110C may be provisioned with an entire, updated protocol for operating ERC and SHA or any other type of blockchain, such that it may verify and ensure compliance with those standards and blockchain functionality among all other users and nodes.

Although user device 110A may further include blockchain 200 or portions thereof and well as blockchain managers and protocols for operating the same, it may be advantageous for user device 110A to be a mobile or lower-powered device such as a smartphone, laptop computer, tablet, or desktop computer to be configured to interface with communication network 150 and be served applications that interface with, and/or provide information and user interface to, blockchain 200. As such, user device 110A may lack blockchain 200 but still receive data or operations based on the same. For example, user device 110A may function as user 599 in example methods, with server 110C functioning as interface 501 providing networked functionality of blockchain 200 to the user.

Node 110B may have a similar configuration to server 110C, or may lack configuration for interfacing with user device 110A. Node 110B may interface, directly or via network 150, with server 110C to grow, validate, mine, access, decrypt, and otherwise interact and operate on blockchain 200. For example, node 110B may be one of several machines supporting a distributed ledger and may store all or portions of blockchain 200, verify and build consensus for changes to blockchain 200, and access or otherwise provide portions of blockchain 200 for example methods. Node 110B may store or operate in accordance with all protocols of the same blockchain and blockchain manager stored and/or verified by server 110C or other nodes 110B, or where node 110B lacks such functionality, such as returning bad consensus indicators, storing invalid blockchain transactions, or failing authentication, it may be excluded from these operations as detected by other nodes 110B or server 110C.

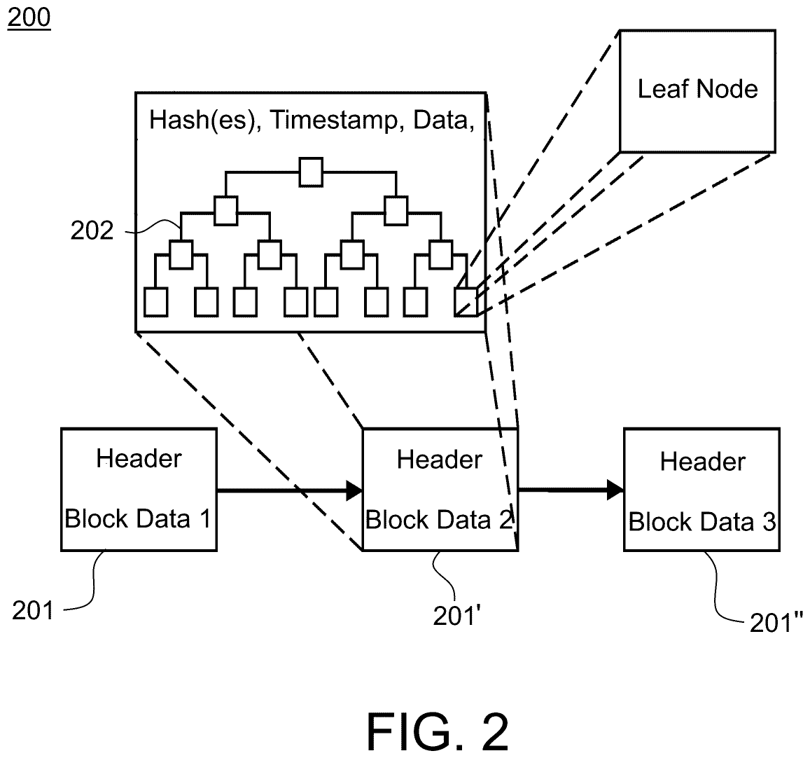

FIG. 2 depicts an example embodiment blockchain 200 useable in connection with example methods. As shown in FIG. 2, blockchain 200 includes at least one block 201 containing underlying data, metadata instructions, smart contracts, pointers, URLs, tokens, etc. and a connective header. Each block 201 may further include Merkle Tree 202 with transactional data. Merkle Tree 202 may cryptographically link data changes or transactions within blocks 201, 201′, 201″. For example, each block 201 may include at least one change in data, new data, transaction, etc. requiring traceability. Merkle Tree 202 may organize the data to facilitate access to the stored transactions, which may be hashed using a cryptographic hash algorithm, and the hash of each transaction may be stored in the tree. Tree 202 may be constructed with the hash of each adjacent node at a same level to create a new node that exists at a higher level in the tree. The root node at the top of the tree reflects the hash of each transaction stored below in the tree. In this way, Merkle Tree 202 may verifiably link all changes and transaction within block 201.

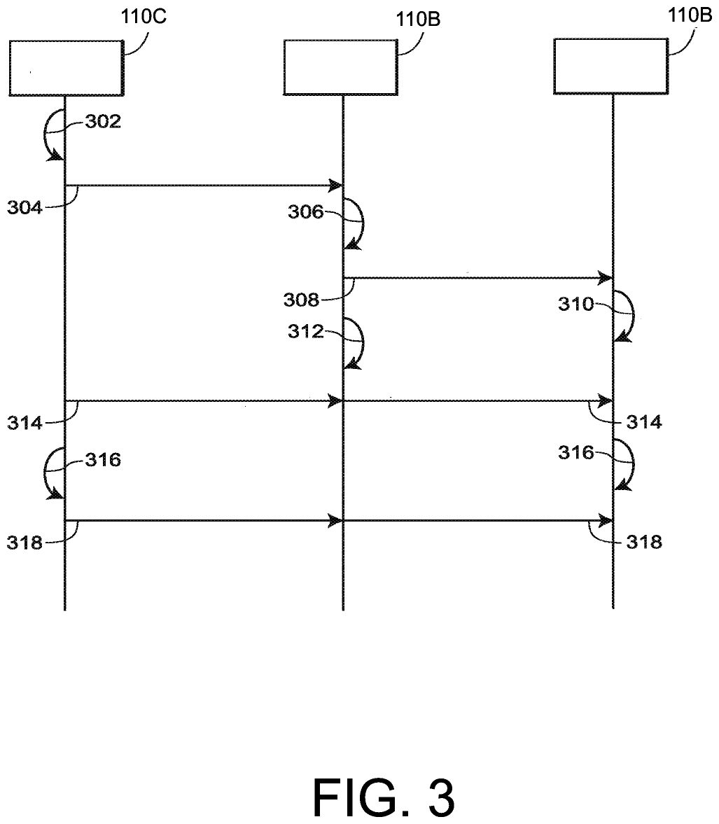

FIG. 3 illustrates an example embodiment action flow between nodes 110B and server 110C of FIG. 1. At 302, server 110C may generate a transaction, such as a user providing new data or a transaction that is being tokenized. The transaction may be transmitted from server 110C to one of nodes 110B at 304. Node 110B may validate the transaction at 306, and, if the transaction is valid, transmit the transaction at 308 to another node 110B. That other node 110B may validate the transaction at 310. At 312, the first one node 110B may compile a block including the validated transaction.

Compiling a block may include proving a stake of ownership of digital currency, generating a solution to a cryptographic puzzle, or other verification method, and linking the block to other blocks through an identifying hash, as described above. Once the block is compiled, node 110B may transmit the block with the proof or solution at 314 to both server 110C and other node 110B. Both server 110C and the other node 110B may then validate the proof of stake or solution to the block at 316. Verifying may include checking a cryptographic key-pair and/or confirming a user holds a represented amount of stake. At 318 nodes 110B and server 110C form a consensus that the solution is valid, thereby forming a consensus on the blocks of transactions stored by all the nodes. Similar functions may occur in generating and storing tokens in accordance with the ERC discussed below in example methods.

### Example Methods

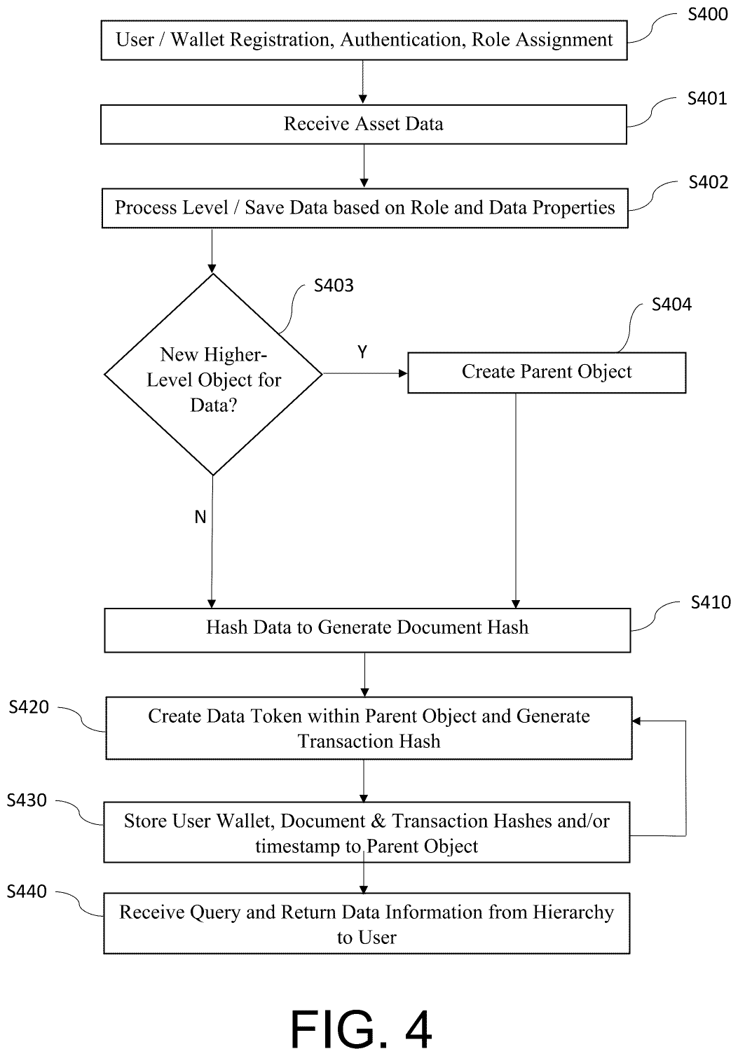

FIG. 4 is a flow chart illustrating an example method of hierarchical data management for real-world assets with an example embodiment system, such as a token-based blockchain described in connection with FIGS. 1-3. As shown in FIG. 4, in S400, a user registers with the system. For example, a user may register through an interface provided on a user device through a website or application-interface, or by an operator of the providing server architecture inputting user intake and/or granting access. The user may be assigned a wallet or associated with their existing wallet, a unique identifier for each user within an example blockchain, as well as sign-in credentials such as user name(s) and/or password(s) for securely accessing the same in S400.

At registration in S400, the user is also assigned or associated with a role for interacting with example blockchains. For example, an operator or owner of the blockchain or governing server may be authenticated and assigned an administrator or owner role. A user contributing asset information may be assigned a contributor or user role according to their relationship with blockchain assets. For example, in connection with a real estate collection in example methods, a governmental actor, such as a department of real estate recordation, building inspection officer, tax record agency, clerk authorized to issue deeds or register ownership, courts issuing orders to settle title, etc. may be assigned an authoritative or government role for differing treatment in example methods. In the same example, a property owner, building lessor, landlord, management company, etc. may be assigned an operator or owner role for unique treatment in example methods. A lessor, sales agent, bidder, contractor, etc. or other party having lower ownership interest or rights in the asset may be assigned a subordinate or renter role for unique treatment in example methods. Still further, a verifying party or node operator seeking only to support or provide consensus for blockchain operations may be assigned a miner or node role for unique treatment in example methods in S400.

Particularly for assets having complex legal status and potentially large real-world value, such as real estate and other multilateral assets, users in S400 may be further verified with proof of identity and control, and screened for potential risk of non-constructive interaction with example methods and blockchains. For example, a new user registering in S400 as a governmental operator may provide officially-issued papers or access through a government-assigned or controlled IP address. A server operator or owner may show local server or root access to be granted such role in S400. An owner or operator may be required to provide a deed, court order, pointer to online government ownership registry, etc. to prove that role.

All users may be required to show proof of identity through, for example, government-issued IDs and/or unique identifiers such as logins or MAC addresses for their user devices. Users may further be screened with anti-money-laundering (AML) tools and fraud screening, including by providing criminal, bank, and/or credit records, proof of location, and by passing background and/or commercially-provided AML checks at registration. Example embodiments and methods may take advantage of an operator login model requiring user authentication with a password over a secured connection and/or using operating-system-native security control and verification on communications devices, to ensure only verified, permitted operators or users gain access. Example embodiment network architectures may also require payment verification, such as providing a digital currency or passing credit card or bank account authentication, to verify identity and/or ability to pay before allowing access and may use location and input verification available through operating system controls or other network functionalities, potentially in combination with user feedback, to prevent or punish location spoofing, user account compromising, bot access, and/or harassment or waste.

Although authentication and roles may be assigned together with access credentials and/or a wallet ID in S400, users may repeat actions in S400 as roles or supporting documents change. For example, a property consumer or lessor initially registered in S400 may convert to an owner or manager in S400 through providing similar documentation and verification of such status requiring its initial assignment in S400. Role and authority changes may also be automatically executed as part of the hierarchical arrangement of asset information below in example methods. For example, when a user that was a previous lessor provides a deed in example methods newly listing the user as an owner and indicates they are an owner, example methods may modify the user account to reflect that new role, upon acceptance of the documentation in example methods.

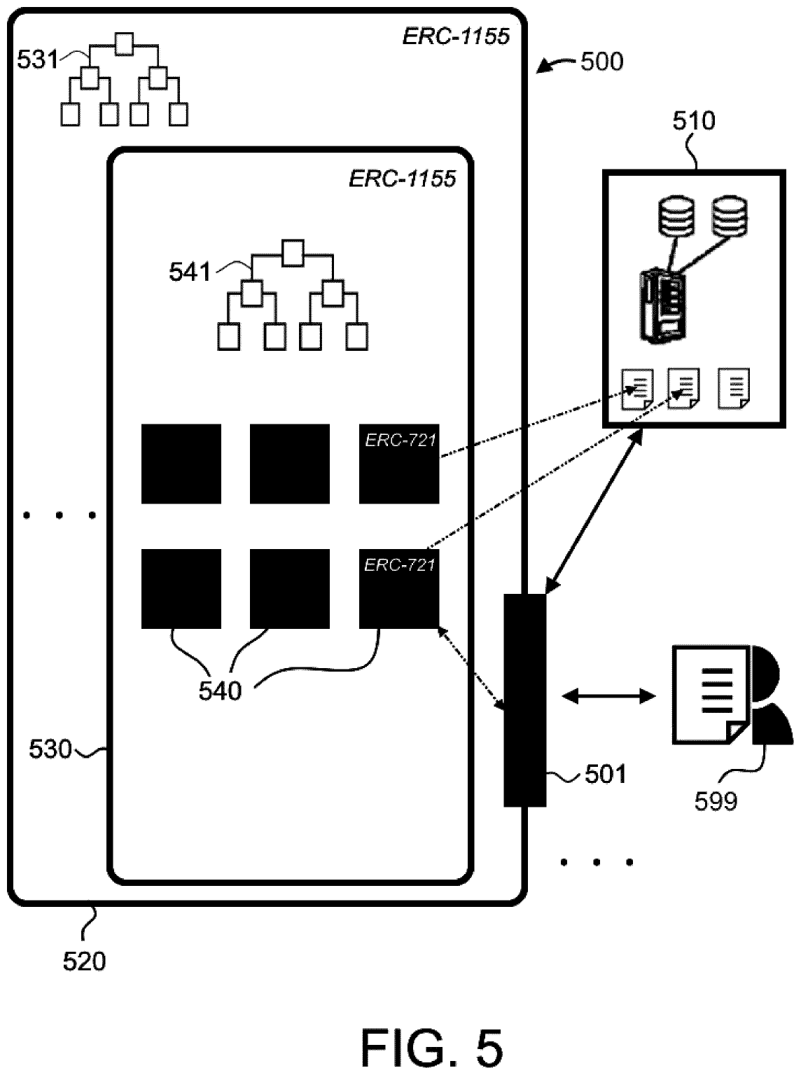

In S401, a user provides data related to an asset to be managed in an example embodiment blockchain hierarchy. In the example of real estate or real property, a user may provide a diverse array of documents, URLs, geotags, reviews, transactions, and other data and metadata relating to an individual property or larger collection of lots or plats, rental or ownership portfolio, entire building, etc. As specific examples, a user registered as a governmental building inspector may provide a PDF of an issued occupancy permit, or a link to a URL containing the same; or an owner user may provide a word processor document or digitally-signed document link of an executed lease for a property. In terms of the example embodiment organizational hierarchy 500 of FIG. 5, user 599 may provide data to server interface 501 operating hierarchy 500 and configured to authenticate, login, and ingest data from users 599. Similarly, in S401, the user may provide a description or representation of the data, for example, inputting through a user interface an indication of “sale” along with an uploaded executed sales contract PDF, potentially with additional details such as purchaser, price, etc.; or an owner may indicate a new appliance was installed and passed inspection, with a contractor receipt for the same, potentially with additional details such as appliance specifications, price, installer, etc.

In S402, the provided data may be initially processed and/or saved based on its document properties, user-generated description, and/or provided user role. For example, raw copies of files like PDFs, word processor documents, images, emails, media, etc. may be separately stored in a storage repository, such as a server or database with large file allocation systems for storing and/or hosting content. Or, for example a provided URL or transaction may be retrieved from or verified against a corresponding website or database serving the same. In terms of the example embodiment organizational hierarchy 500 of FIG. 5, repository 510 may receive such documents and store them, potentially in conventional file systems and/or relationship database in S402.

Additionally, interface 501 may extract out representative data submitted by user 599 short of the entire document itself for use in example methods, while storing, and/or serving provided data document properties from repository 510 in S402. Similarly, repository 510 may be operated by a third-party or omitted entirely, with received data being wholly stored within interface 501 or another internal repository in hierarchy 500.

In S403-S404, a relevant hierarchy target for the data provided in S401 is determined or created, based on the provided data and/or user role. For example, organizational hierarchy 500 of FIG. 5 may be created and/or populated at properly-identified levels in S403 onward. Hierarchy 500 may be a single-purpose vehicle with levels of information and document storage mirroring relationships among complex real-world assets and transactions. For example, hierarchy 500 may reflect relationships and organizations of real estate ownership and transactions across all relevant actions, documents, and data or a given property or portfolio. Further examples of a three-level hierarchy for a real estate asset are discussed below, with the understanding that any 2+ tier hierarchy for any complex transactional circumstance can be manages by example embodiment hierarchy 500.

Top-level object 520 may be a parent or original object stored in a blobnet or object storage that collects and organizes all data relevant to the same. For example, top-level object 520 may be a token generated under the Ethereum token standards, such as ERC-1155Delta. Top-level object 520 may thus be imbued with the protocol and authority to mint or create lower-level objects as tokens assigned to top-level object 520. Top-level object 520 may have a unique ID and correspondence with a real-world asset, such as a building given by an address, deed, recorded plat, geotag, financing structure, etc., including collections of the same, that might be physically stored in raw and full form in repository 510 or another storage.

In S403 of FIG. 4, it is determined if the provided data is associated with an existing top-level object 520. For example, in S401 interface 501 may receive user input indicating the document is a PDF lease associated with an existing building represented by a top-level object, or, for example, interface 501 may determine through user input and a government registry in S401 that provided data is an initial construction permit for a property having no previous data and thus top-level object. In the latter instance, where there is no associated top-level object, in S404 of FIG. 4, the system creates an appropriate container or parent object as the top-level object 520.

S403-S404 may be repeated for lower hierarchy tiers, potentially for all such tiers. For example, top-level object 520 may include multiple tiers or nested levels of data organized based on type, transaction, subject, etc. In the example of real estate, top-level object 520 organized around a single property may include mid-level objects 530, one collecting all leases for the property, another collecting all sales offers for the property, another collecting all architectural or engineering documentation and permits for the property, etc. Alternatively, different mid-level objects 530 could be created based on file types, submitting user role, etc., such as with one for raw received PDFs, another for public-website-retrieved HTML documents, another for media filed created by users, etc. all related to top-level object 520. Operators may designate and/or create any number of mid-level objects 530, giving effect to any type of organization.

Mid-level objects 530 may have identical properties to or copied property subsets from top level object 520, and may be subordinate to the same. For example, mid-level objects may be stored in the blobnet or object storage with all other cryptographic information generated in example methods, and may be a token generated under ERC-1155. Mid-level objects 530 may similarly have factory authority and capacity to mint or create lower-level objects as tokens assigned to themselves and top-level object 520 and a unique ID and correspondence with a real-world asset. S403-S404 may be repeated for each tier or level of mid-level object 530, to ensure all received data has a uniquely-identified parent object. Similarly, no mid-level objects 530 may be used in example methods, only top-level object(s) 520 containing all bottom tier tokens. Although S403-S404 may be executed repeatedly upon data receipt, it is also permissible for operators to create all tiers and containing parent object ab initio regardless of data receipt, such that S403 always returns a no result and branch, or to omit S403-S404 entirely where all tiers are already created.

In S410-S430, example methods cryptographically set the received data within the hierarchy, and otherwise modify the hierarchy, to allow durable and quick verification of data organization and transactions. In S410, at least a portion of the received data from S401 is hashed to generate a document hash uniquely identifying that data. For example, hashing in S410 may use Secure Hash Algorithm 2, such as SHA-256 or SHA-512, to generate hashes from received data. The hashing in S410 may use extracted properties from S402. For example, a file, object, document, etc. received in S401 may have a unique byte structure that is hashed in S410 to generate a corresponding encrypted hash string. The submitting user's document or transaction description, wallet ID, timestamp, role, data type, etc. may be additionally hashed with the byte structure hash in S410 to create the document hash. In this way, received data from S401, regardless of document type, description, metadata, repository location, etc. may have a unique cryptographic signature generated in S410.

In S420, the received data is tokenized with its document hash within the parent object determined and/or created in S402 and S403. As shown in FIG. 5, tokens 504 for each received and associated piece of data are created in containing mid-level object 520. Each token 504 is unique and generated in response to a uniquely-associated user data submission from S401. For example, if mid-level object 530 is operating on ERC-1155, object 530 may create ERC-721 tokens 540 given object 530's creation authority under the protocol. The document hash created in S410 may be set within token 540, along with timestamp and wallet identification of the submitting user. Additionally, in S420, a URL or other record reflecting the document hash, timestamp, wallet identification and/or any underlying data used in creating the document hash may be created for each token.

The entire token creation transaction in S420, including an identifier of the created token, created token data or characteristics such as identifier, timestamp, creating wallet, etc., and/or the URL serving the underlying hash(es) and additional token data, may themselves be hashed, to generate a transaction hash. For example, SHA-256 or SHA-512 may be used to generate a unique hash string representing the transaction hash from some or all of this underlying data. In this way, the transaction hash can uniquely associate with all provided, abstracted, and hashed data together for each piece of information added and tokenized in S420.

In S430, the transaction hash, potentially with providing user wallet ID, URL with data properties, and creation timestamp are saved in the associated container. For example, the transaction hash may be stored in the creating containing mid-level object 530, or in the instance that hierarchy 500 has no mid-level objects, in top-level object 520. The transaction hash may be saved together with previous transactions in a Merkle Tree and/or added into token dictionary 541 as a data object with hashes as JSON for object 530. For example, dictionary 541 may be an array or hashmap storing all transaction hashes against object or token identifier for all contained objects within the mid-level or top-level objects.

As shown in FIG. 4, S430 and/or S420 may be reiterated for each level of example embodiment hierarchy 500. For example, the transaction hash and its writing into a container's dictionary may be made for each containing object, up to a top-level object 520 with hierarchy dictionary 531 that may collect top-level hashes iterated up through each hierarchy tier. In this way, a containing object may include a linked and verifiable record, such as through Merkel-proofing a dictionary against all contents, of all associated pieces of data tokenized within it, including a separate document hash uniquely identifying the data, as well as providing user and timestamp of the token creation. Because the transaction hash is based on the document hash, it is possible to verify the accuracy of all underlying documents associated with a particular containing object, all the way up to a top-level object. Similarly, by separately storing document hashes and data underlying a transactional has, and potentially serving the same through a URL, example embodiment hierarchy may provide a compact and quickly-searchable and verifiable record of each transaction recorded in the same, organized among any number of tiers associating related data. Any of these pieces of data may be used to verify a document, provide a traceable receipt to the user, or determine a change in state of underlying data.

In S440, any type of data or relationship from the built hierarchy may be provided to a querying user or verifying operator, potentially well after creation or dormancy following previous steps in example methods, and to users different than those supplying data. For example, in S440, the providing user from S401 may be provided with the URL of the hash(es) and/or underlying document properties established in S402 and used in generating hashes in S410-S430. Or a user providing a document may be provided with the actual transaction hash or other token identification showing acceptance and position of their data within the hierarchy.

Or, for example, a user may provide a document or media in S440 associated with a particular asset, such as a PDF lease associated with a building for the parent object, and the system may hash it and search for the hash within the hierarchy to return an indication of what property or what user the lease is associated with, or an indication that the document has not been hashed and is potentially not valid. Or, for example, a user may query a particular wallet identifier, and every token having that wallet ID may be returned, providing a complete list of actions and data provided for a particular user, potentially across all types of documents and transactions within a parent object. Because token dictionary 541 may contain a unique and searchable list of all token information contained within the dictionary for an object, Merkle-proofing, searching, and verification of transaction data and data origin may be particularly fast and easy in example embodiment hierarchies.

FIG. 5 is an illustration of example embodiment organizational hierarchy 500 that may be created, enriched, and/or queried in example methods described above. Hierarchy may be stored on physical media organized as object storage as a blobnet or in conventional file systems. In an example using ERC protocols, each containing or top-level object 520 and 530 has ERC-1155Delta creation authority to mint or generate associated ERC-721 tokens 540 reflecting data submissions related to their object type. Mid-level objects 530, however, may not have ability to create tokens in any other mid-level object or a different top-level object. The unique identification of each object 520, 530, etc. is saved and persisted in created lower containing objects and tokens therein. In this way, each object and token inherits an identifier reflecting its parental or containing relationship. These identifiers and permissions may be unchangeable and protected by a protocol server or blockchain manager, such that all levels of the hierarchy persist forever with unique identifiers reflecting their hierarchy position.

Interface 501 may be provided on a server or application network and provide authorized users 599 access to hierarchy 500. Interface 501 may store this registry and authenticate new users in S400, as well as store relevant hierarchy protocols and blockchain managers and programming or other configuration to execute example methods. For this, interface 501 may provide users 599 with authentication challenges as well as upload or reference portals for provided data and description of the same. Interface 501 may further provide searching or query fields and responses to users 599 based on their access level to hierarchy 500.

Actions throughout example embodiment hierarchies may include user authentication, data verification, privacy controls, and/or content screening. This will also extend to use an authentication key or access key or device-based unique key or any combination thereof. In this way, one or more operators can be blocked or denied access. For example, operators and other parties may be limited or not provided with identifying information of one another, or limited to only wallet identifiers, such that a party submitting information for a token, a party operating the hierarchy, and/or a party querying the same may remain personally anonymous. Data may be encrypted and not retained at one or all points in example methods, such that there may be no discoverable record of signals from data streams, independent media, origin and/or limitation information in regard to such content, existence, performance, etc.

Example embodiments and methods thus being described, it will be appreciated by one skilled in the art that example embodiments may be varied and substituted through routine experimentation while still falling within the scope of the following claims. For example, although different hierarchy objects are described as operating on various Ethereum standards, other cryptographic protocols may be used simply through proper provisioning of server programming, storage format, and blockchain managers in example embodiments—and fall within the scope of the claims. Such variations are not to be regarded as departure from the scope of these claims. The claims below are not intended to be construed under 35 U.S.C. § 112(f) unless explicit means-plus-function language “means for” and “step for” are recited therein.

1. A method implemented on a computing system having one or more processors, a memory, and a network interface connected to a network, the method comprising:
receiving, by the system, at least one document regarding a real estate asset, from a computing device associated with the user;
storing the document in at least one file repository;
hashing at least properties of the document and a location of the document in the file repository into a token;
storing the token in a target object in a lowest tier of a cryptographic hierarchy separate from the file repository, wherein the target object is associated with the real estate asset and a type of the document;
hashing the token to generate a transaction hash; and
storing the transaction hash in an object on a higher tier than the lowest of the tiers and containing the target object.

2. The method of claim 1, wherein the information is a digital document containing a transaction or new information about the real estate asset, and wherein the document hash is a hash of the byte structure of the digital document.

3. The method of claim 2, wherein the document hash is created with a SHA-2 hash function.

4. The method of claim 1, wherein the hashing the token includes hashing a wallet identification of the user, a date of the token creation, and a URL pointing to a webpage displaying the properties.

5. The method of claim 1, wherein the cryptographic hierarchy contains at least three tiers.

6. The method of claim 1, wherein the object is an ERC-1155 object storing multiple tokens, and wherein the token is an ERC-721 token.

7. The method of claim 1, further comprising:
providing, from the system to the computing device associated with the user, a URL pointing to a webpage displaying the properties and the document hash.

8. The method of claim 1, further comprising:
repeating the receiving, comparing, hashings, and storing a plurality of times each for a different user so as to create a plurality of the tokens each for a different piece of information regarding the real estate asset, wherein each of the storings stores all the transaction hashes together in a hash dictionary in the object on the higher tier.

9. The method of claim 8, further comprising:
verifying authenticity of the plurality of tokens by decrypting and comparing the hash dictionary against the properties of the information.

10-20. (canceled)

21. A non-transient object memory with associated processor configured in a cryptographic hierarchy to store objects in the object memory as:
a top-tier container;
a plurality of lower-tier containers within the top-tier container;
a plurality of tokens within the lower-tier container, wherein each token corresponds to a document regarding a real estate asset storied in a file repository separate from the object memory, wherein the tokens are hashed from properties of the document and a location of the document in the file repository;
a dictionary of hashes stored in the lower-tier container including hashes of the tokens stored in the respective lower-tier container; and
a dictionary of hashes stored in the top-tier container including all hashes from the plurality of lower-tier containers.

22. The memory of claim 21, further comprising:
a blockchain manager instructing the processor to operate in the ERC protocol; and
instructions, that when executed by the processor cause the processor to,
provide an interface to a user to receive the document;
determine a lower-tier container for the token, wherein the token is an ERC-721 token.

23. The memory of claim 16, wherein the hashings are performed with a SHA-2 hash function.

24. The memory of claim 16, wherein the top-tier container is associated with the real-estate asset, and wherein the lower-tier containers are each associated with a distinct type of transaction with the real-estate asset, and wherein the lower-tier containers each store only ERC-721 tokens for the respective distinct type of transaction.

25. The memory of claim 24, wherein the distinct types of transactions include sales, leases, taxation, and government permitting.
